(19) United States
(12) Patent Application Publication
(10) Pub. No.: US 2013/0127700 A1
(43) Pub. Date: May 23, 2013

(54) Backlight Module, Backplane and LCD Device

(71) Applicants: Yuchun Hsiao, Shenzhen (CN); Yicheng Kuo, Guangdong (CN); Chong Huang, Guangdong (CN); Jiahe Cheng, Guangdong (CN)

(72) Inventors: Yuchun Hsiao, Shenzhen (CN); Yicheng Kuo, Guangdong (CN); Chong Huang, Guangdong (CN); Jiahe Cheng, Guangdong (CN)

(21) Appl. No.: 13/376,184

(22) PCT Filed: Dec. 3, 2011
(86) PCT No.: PCT/CN2011/083413

§ 371 Date: Dec. 4, 2011

(30) Foreign Application Priority Data
Nov. 18, 2011 (CN) 201110369270.6
Nov. 28, 2011 (CN) 201110369642.5

(51) Int. Cl. G09G 3/36

(52) U.S. Cl. 345/102

(57) ABSTRACT

The present invention discloses a backlight module, a backplane and an LCD device. The backlight module comprises a backplane, a PCB and locking pieces for fixing the PCB on the backplane; the backplane surface is provided with chutes, and the locking pieces are selectively arranged in the chutes by the fixed structure at the bottom of each locking piece. In the present invention, because the backplane surface is provided with chutes for arranging the hillocks, the hillocks are fixed in the random positions of the chutes. Thus, the hillocks are arranged in the corresponding positions of the chutes in accordance with the size of PCB, so that the backplane can be adapted for PCBs of different size, and its generality can be increased. In addition, hillocks and through holes of corresponding number can be arranged in accordance with the number of different components. Thus, the backplane has higher generality, and then the production cost and the processing cost of the backplane can be reduced.

### TECHNICAL FIELD

The present invention relates to the field of liquid crystal displays (LCDs), and more particularly to a backlight module, a backplane and an LCD device.

### BACKGROUND

As a device for providing a light source in an LCD device, a backlight module comprises a backplane, a light guide plate, an optical diaphragm, light-emitting diode (LED) light bar(s) and the like; wherein, most components are locked and fixed on the backplane; for example, a printed circuit board (PCB) is locked on the backplane by hillock(s).

Hillock(s) is a structure which is arranged on the backplane and is used for fixing the PCB and the like. In general, the hillock protrudes from the backplane surface, and the PCB is fixed on the hillock by screws or other locking pieces; then the short circuit caused by direct contact between the PCB and the backplane surface is avoided. An existing backplane is as shown in FIG. 1, and the hillocks 80 on the backplane are integrally stamped and formed on the backplane when the backplane is made. Thus, the positions of the hillocks 80 on the backplane are fixed so that it is difficult to adapt for PCBs of different size; meanwhile, for the backlight modules requiring PCBs of different size and components of different number, corresponding backplanes are required to be mold-made; and for PCBs of different size, new backplanes are required to be mold-made. Thus, the generality of backplanes is poor, and the production cost is high under the condition.

### SUMMARY

The aim of the present invention is to provide a backlight module with good generality, a backplane and an LCD device.

The purpose of the present invention is achieved by the following technical schemes. A backlight module comprises a backplane, a PCB and locking pieces for fixing the PCB on the backplane; the backplane surface is provided with chutes, and each locking piece is arranged in each chute by the fixed structure at the bottom of the locking piece.

Preferably, each chute is provided with a locking piece for fixing the PCB, and the locking piece is arranged in the corresponding position of the chute in accordance with the size of PCB. By determining the size of PCB, the locking pieces are arranged in the corresponding positions of the chutes. Thus, PCBs of different size can be arranged by the backplanes of the same size.

Preferably, each locking piece is a hillock, and the bottom of the hillock is provided with a fixed structure for arranging the hillock in the chute. The hillock has good effect for locking PCBs, and avoids the short circuit of PCB circuits.

Preferably, the fixed structure is a threaded hole arranged at the bottom of the hillock. The hillock can be conveniently arranged on the backplane by screw(s), and can be removed.

Preferably, the threaded hole penetrates through the hillock. Thus, the PCB, the hillock and the backplane can be mutually fixed by only one screw; the three components are fixed because the screw passes through the PCB, the hillock and the backplane and the screw is locked by a nut.

Preferably, the fixed structure is a rivet integrally arranged at the bottom of the hillock. The riveting mode has the advantages of simplicity, convenience, quickness and high reliability, and can be accomplished by machinery.

Preferably, each locking piece is an independent mushroom head. The mode for locking PCB by the mushroom head is convenient and quick.

Preferably, the locking piece is arranged on the backplane by screw(s), and the locking piece can be moved in the chute. Before arranging the PCB, the locking pieces are arranged on the backplane in advance, but are not tightly locked, so that the locking pieces can be moved in the chutes. Thus, when locking PCBs of different size, the locking pieces are moved to the corresponding positions; and after locking the PCBs, the locking pieces are tightly locked on the backplane. Thus, the installation process becomes quicker without measuring positions in advance.

Preferably, the locking pieces are arranged on the backplane by screws or rivets and are tightly locked, and the locking pieces are fixed in the chutes. The mode has the advantage of high installation accuracy.

A backplane, the backplane surface is provided with chutes for arranging the locking pieces.

An LCD device comprises any one of the aforementioned backlight modules.

In the present invention, because the backplane surface is provided with chutes for arranging the hillocks, the hillocks are fixed in the random positions of the chutes. Thus, the hillocks are arranged in the corresponding positions of the chutes in accordance with the size of PCB, so that the backplane can be adapted for PCBs of different size, and its generality can be increased. In addition, hillocks of corresponding number can be arranged in accordance with the number of different components. Thus, the backplane has higher generality, and then the production cost and the processing cost of the backplane can be reduced.

### BRIEF DESCRIPTION OF FIGURES

FIG. 1 is a simplified structure diagram of an existing backplane;

FIG. 2 is a simplified structure diagram of a backplane of an embodiment of the present invention;

FIG. 3 is a simplified structure diagram of one hillock of an embodiment of the present invention;

FIG. 4 is one structure diagram of a PCB locked by a hillock of an embodiment of the present invention;

FIG. 5 is a simplified structure diagram of another hillock of an embodiment of the present invention;

FIG. 6 is other structure diagram of a PCB locked by a hillock of an embodiment of the present invention; and

FIG. 7 is a simplified structure diagram of a third hillock of an embodiment of the present invention.

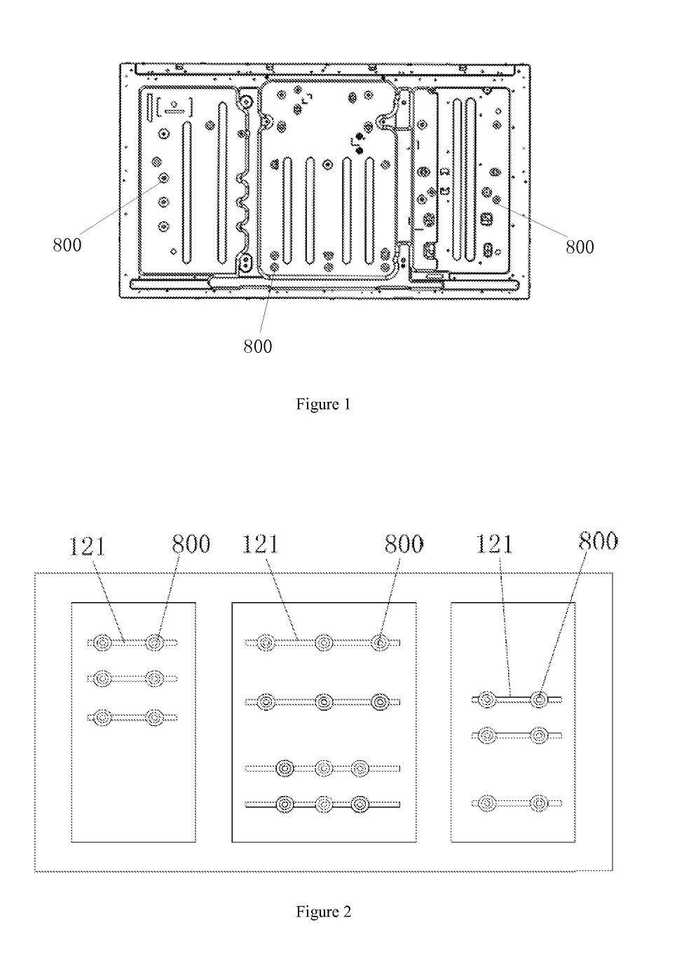

Wherein: 1. backplane; 121. chute; 800. hillock; 810. threaded hole; 811. screw; 812. nut; 820. rivet; 300. PCB.

### DETAILED DESCRIPTION

The present invention provides an LCD device. The LCD device comprises an LCD panel and a backlight module. The bottom of the backlight module is provided with a backplane. The backplane is made by processing one panel, multiple panels or multiple panels of different material, and the backplane surface is provided with chutes for arranging the hillocks. In accordance with the scheme, the invention will further be described in detail in accordance with the following preferred embodiments.

FIG. 2 shows a backplane formed by processing an integral panel. The backplane surface is provided with chutes 121, and the length, the position and the number of the chutes 121 are correspondingly designed on the backplane surface in accordance with the PCBs of different size. Each chute 121 is provided with a hillock 800, and the hillock 800 as an independent part is additionally arranged in the chute 121. The position is adjusted in accordance with the size of PCB, and is adjusted within the chute 121. Thus, the backplanes of the type can be generally used in various backlight modules.

In order to facilitate installation, the hillocks are arranged in the chutes in advance, but the screws are not tightly locked. Thus, the hillocks can be slid in the chutes. The hillocks are slid to the corresponding positions in accordance with the size of PCB, and the screws are tightly locked after locking the PCB. The hillocks are directly fixed by screws or rivets in accordance with the size of PCB; then the PCB is locked to reduce the steps in processing.

Of course, the PCB can be locked on the backplane by other similar locking pieces such as mushroom heads and the like besides hillocks. The mushroom heads are made into independent existing parts and are arranged in the chutes as the hillocks, and the PCBs of different size are locked in the same way.

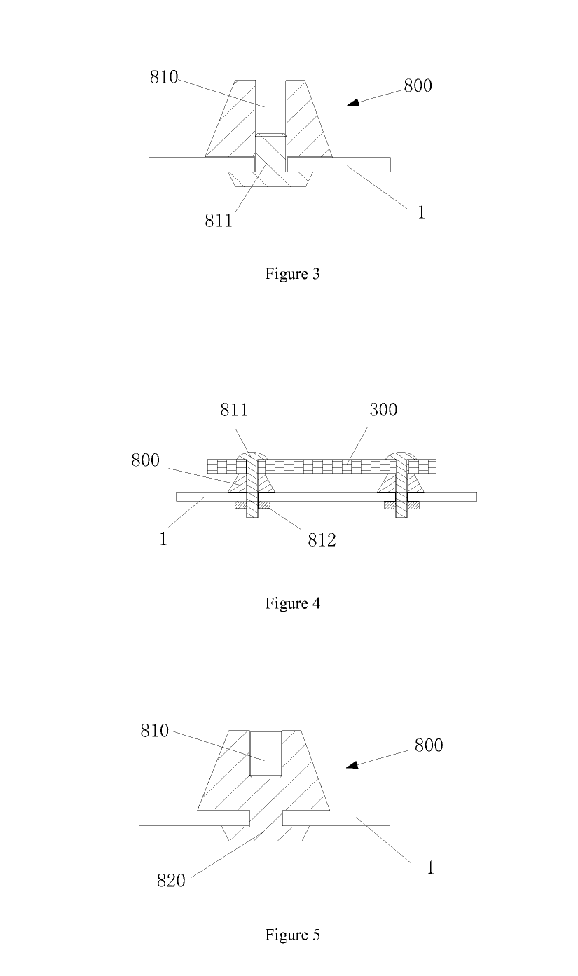

FIG. 3 and FIG. 5 show a hillock 800 as an independent part used in the embodiment. The hillocks of this type are not formed on the backplane when the backplane is manufactured, but the hillocks 800 are arranged in the corresponding positions of the chutes 121 of the backplane 1 when the hillocks are used, to achieve the aim of positioning the PCB and the like of different size by flexibly using the hillocks 800.

As shown in FIG. 3, the hillock 800 has a threaded hole 810 for arranging and fixing the PCB and the like, and the threaded hole 810 penetrates through the independent hillock 800. Thus, the independent hillock 800 can be fixed on the backplane 1 from the lower part through a screw 811, and can fix the PCB from the upper part. Accordingly, the backplane 1 is provided with hillock mounting holes, namely chutes, of which the size is corresponding to that of the threaded hole 810 of each hillock 800, so that the hillock 800 can be fixed on the backplane. Similarly, the PCB, the hillock and the backplane are fixed by using one screw matching with a nut. As shown in FIG. 4, because the threaded hole penetrates through the whole hillock 800, the PCB 300 is directly locked on the backplane 1 by a screw 811 matching with a nut 812.

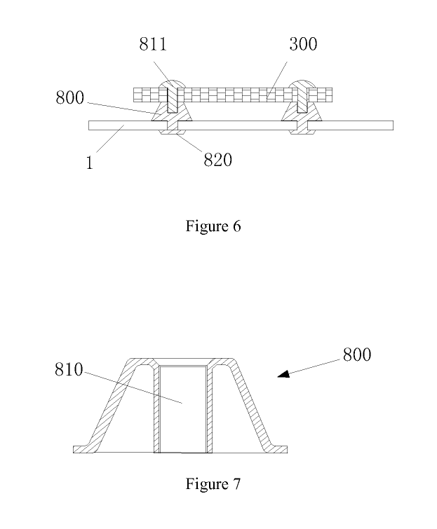

In order to facilitate installation, as shown in FIG. 5, the bottom of the hillock is designed into a structure similar to a rivet, namely the rivet and the hillock are integrally formed. The lower end of the hillock 800 is connected with the backplane 1 by riveting, namely the hillock 800 is riveted on the backplane 1 by a rivet 820. Compared to the screwing mode, the riveting mode can be quickly achieved, and can be accomplished by machinery so that the production efficiency can be increased. As shown in FIG. 6, the hillock 800 is fixed on the backplane 1 by a rivet 820, and then the PCB 300 is fixed on the hillock by a screw 811, so that the PCB 300 is locked.

To save material and facilitate processing, the hillock can be formed by directly stamping a panel; as shown in FIG. 7, the inside of the hillock 800 is of a hollow structure, and the whole hillock 800 is made of panel material, which saves material and facilitates production.

Of course, the shape of the independent hillock 800 in the embodiment is not limited to the conical section shape shown in the figure, other shape such as square can achieve the corresponding purpose.

In the embodiment, corresponding hillocks are arranged in corresponding positions in accordance with the size of PCB of the backlight module; meanwhile, hillocks of corresponding number are arranged in accordance with the number of different PCB components.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

1. A backlight module, comprising: a backplane, a PCB and locking pieces for fixing the PCB on the backplane; said backplane surface is provided with chutes, and said locking pieces are arranged in said chutes by a fixed structure at the bottom of each locking piece.

2. The backlight module of claim 1, wherein each chute is provided with a locking piece for fixing the PCB, and the locking piece is arranged in the corresponding position of the chute in accordance with the size of PCB.

3. The backlight module of claim 2, wherein each said locking piece is a hillock, and the bottom of said hillock is provided with a fixed structure for arranging the hillock in said chute.

4. The backlight module of claim 3, wherein said fixed structure is a threaded hole arranged at the bottom of the hillock.

5. The backlight module of claim 4, wherein said threaded hole penetrates through the hillock.

6. The backlight module of claim 3, wherein said fixed structure is a rivet integrally arranged at the bottom of the hillock.

7. The backlight module of claim 2, wherein said locking piece is an independent mushroom head.

8. The backlight module of claim 2, wherein the locking piece(s) is fixed on the backplane by screw(s), and the locking piece can be moved in the chute.

9. The backlight module of claim 2, wherein said locking pieces are fixed on the backplane by screws or rivets and are tightly locked, and said locking pieces are fixed in said chutes.

10. A backplane, the backplane surface is provided with chutes for arranging the locking pieces.

11. An LCD device, comprising: the backlight module of claim 1.

12. An LCD device, comprising: the backlight module of claim 2.

13. An LCD device, comprising: the backlight module of claim 3.

14. An LCD device, comprising: the backlight module of claim 4.

15. An LCD device, comprising: the backlight module of claim 5.

16. An LCD device, comprising: the backlight module of claim 6.

17. An LCD device, comprising: the backlight module of claim 7.

18. An LCD device, comprising: the backlight module of claim 8.

19. An LCD device, comprising: the backlight module of claim 9.
